(19) United States
(12) Patent Application Publication
(10) Pub. No.: US 2009/0283510 A1
(43) Pub. Date: Nov. 19, 2009

(54) FOOD WARMER AND METHOD FOR CONSTRUCTING SAME

(75) Inventors: James J. Johnston, St. Petersburg, IL (US); Andrius Zemaitis, Naperville, IL (US); Carlos Jines, Oakbrook, IL (US)

Correspondence Address: GREENBERG TRAURIG, LLP, 77 WEST WACKER DRIVE, SUITE 3100, CHICAGO, IL, 60601-1732, US

(73) Assignee: Methode Electronics Inc., Chicago, IL (US)

(21) Appl. No.: 12/122,127

(22) Filed: May 16, 2008

(51) Int. Cl. H05B 3/34; A21B 1/52

(52) U.S. Cl. 219/400; 219/387; 29/611

(57) ABSTRACT

A portable food warmer is provided with a powered heating element, includes an enclosure, formed from an outer shell and an inner layer, with the powered heating element positioned between the outer shell and the inner layer. A steel rack is provided to support food items contained therein. The powered heating element preferably is in the form of a carbon fiber ribbon, wrapped around the enclosure, between the outer shell and inner layer.

### BACKGROUND OF THE INVENTION

1. Field of the Invention

The present invention relates in general to devices for maintaining materials at a desired temperature above ambient, and particularly for such devices as are used in the transportation and delivery of prepared pre-cooked food products.

2. The Prior Art

Many methods and devices exist for the transportation of already-prepared “hot” food products. Some of these methods and devices rely simply on attempting to contain and prevent heat loss from the prepared food, through the use of insulated containers (e.g., Styrofoam “coolers”, insulated bags having metalized surfaces, vacuum bottles and containers using air gaps as insulation). Such unpowered systems eventually lose heat to their ambient surroundings, leading to loss of temperature in the prepared food products.

Other food product transportation systems may employ pre-heated elements installed in the walls of a container, such as pre-heated ceramic discs. However, these systems also will eventually lose heat, leading to heat loss in the food products.

Powered containers and systems exist for maintaining food at an elevated temperature; however, such powered systems tend to be too large in scale to be readily portable.

It would be desirable to provide an apparatus and system for transporting prepared “hot” food products, which does not suffer from continual heat loss, and which is readily portable.

### SUMMARY OF THE INVENTION

The present invention comprises in part a food warmer. In an embodiment of the invention, the food warmer comprises a box having an internal cavity, an opening defined in a face thereof, and a movable cover cooperating with the opening, to enable access to the internal cavity. The box may include an outer shell; an innermost facing layer; an insulation layer disposed between at least portions of the outer shell and at least portions of the innermost facing layer; and a powered heating system disposed at least in part, along inwardly-facing surfaces of at least portions of the insulation layer.

The present invention also comprises a method for fabricating a food warmer, comprising the steps of:

providing a box, having an internal cavity, an opening defined in a face thereof, and a movable cover cooperating with the opening, to enable access to the internal cavity, the step of providing a box further including the steps of

forming an outer shell;

placing an insulation layer within the outer shell;

providing a powered heating system disposed at least in part, along inwardly-facing surfaces of at least portions of the insulation layer;

placing an innermost facing layer within the outer shell, so that the insulation layer is disposed between at least portions of the outer shell and at least portions of the inner facing layer.

### BRIEF DESCRIPTION OF THE DRAWINGS

FIG. 1 is a perspective view of a food warmer according to an embodiment of the invention.

FIG. 2 is a top view of the food warmer of FIG. 1.

FIG. 3 is a front view of the food warmer of FIG. 1.

FIG. 4 is a side elevation of the food warmer of FIG. 1.

FIG. 5 is a top view of a heating element assembly, according to an embodiment of the invention.

FIG. 6 is a perspective exploded view thereof.

FIG. 7 is a front exploded view thereof.

FIG. 8 is an enlarged fragmentary sectional view, taken along line 8-8 of FIG. 4.

FIG. 9 is a schematic illustration of the electrical circuitry for a food warmer according to an embodiment of the invention.

### DETAILED DESCRIPTION

While this invention is susceptible of embodiment in many different forms, there is shown in the drawings, and described in detail herein, one embodiment, with the understanding that the present disclosure is to be considered an exemplification of the principles of the invention and is not intended to limit the invention to the embodiment illustrated.

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

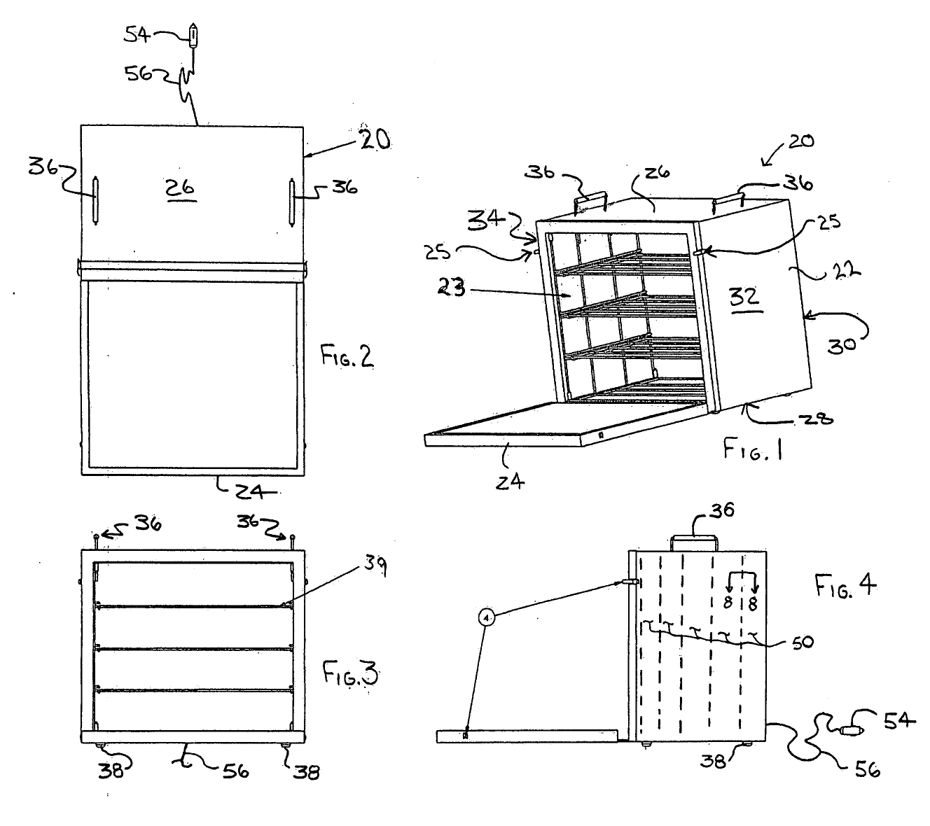

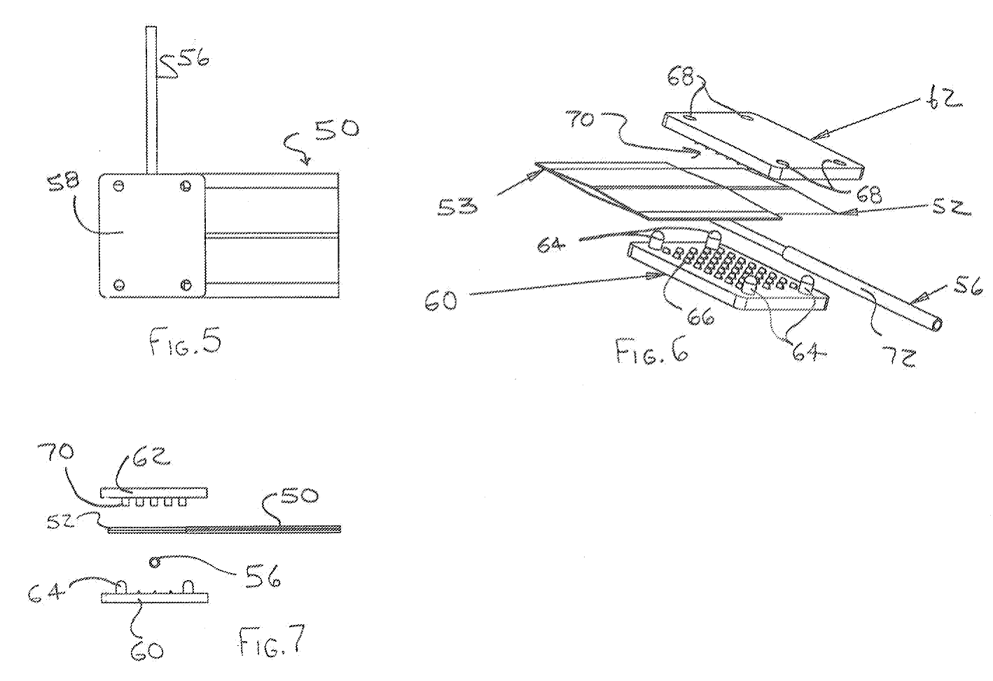

FIGS. 1-4 illustrate a food warmer according to the principles of the present invention. Food warmer 20 includes a parallelepiped box 22 (or other three dimensional shape), having a hinged front wall 24, and top wall 26, bottom wall 28, back wall 30, and side walls 32, 34. Referring, by way of example, to FIG. 8, which is an enlarged fragmentary sectional view of side wall 32, taken along line 8-8 of FIG. 4, each of the walls is preferably fabricated from a plastic or fabric (e.g., corrugated polypropylene, molded thermoplastic, canvas, nylon, etc) shell layer 40 for strength and light weight, with an innermost facing layer 42 being, in embodiments of the invention, a laminate of aluminum foil 44 and polyester film 46. An insulation layer 48 of, e.g., polystyrene foam, preferably having a relatively high R value (e.g., R>4), is disposed between the outer shell layer 42 and the inner wall layer 44, along all of the top, bottom, side and rear walls of box 22, and may be disposed between the outer shell layer 42 and inner wall layer of the front wall of box 22, to maximize containment of heat within food warmer 20.

Hinged front wall 24 may be held in place in a closed position by any suitable method, such as by simple friction, small projections on the door mating with recesses in structure surrounding and defining front opening 23 of box 22 or by any suitable latching method, such as by magnetic catches, snaps and straps, mechanical latches (generally shown at 25 in FIG. 1), etc.

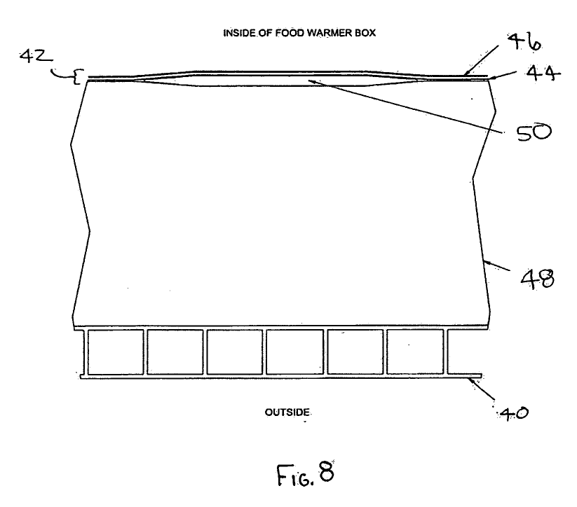

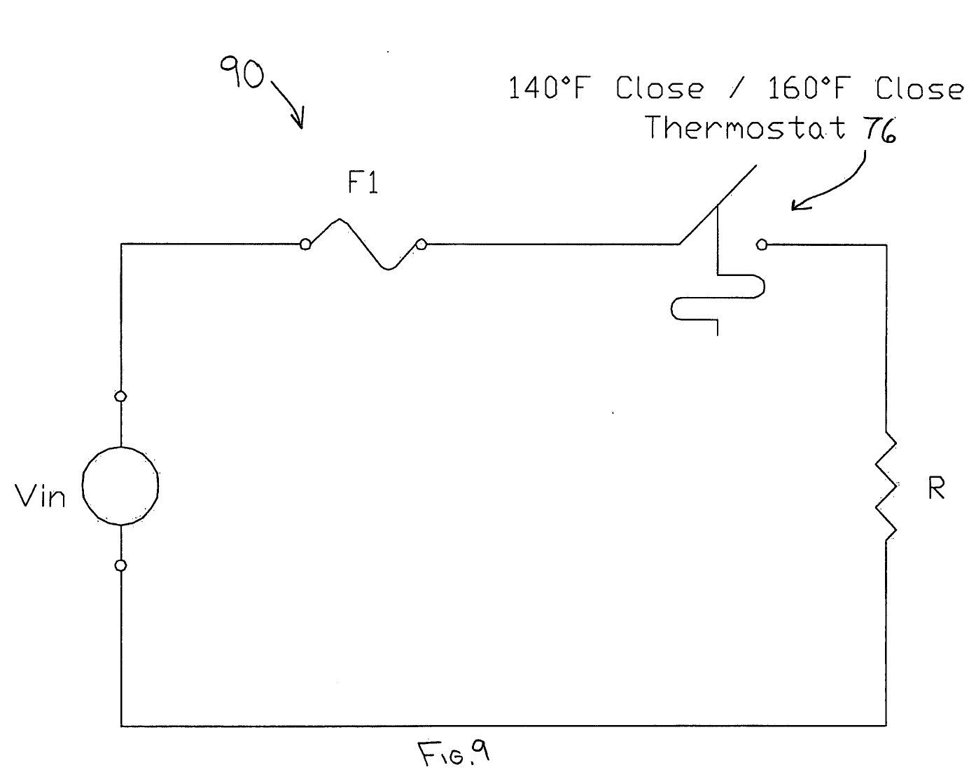

To provide the heating effect, a heating element 50 is placed between the insulation sheet 48 and the inner wall layer 44. Heating element 50, in embodiments of the invention, includes flattened carbon fiber strip 52, and is wound around the interior of the warmer 20, as suggested by the broken lines in FIG. 4. Heating element 50 is provided, for most of its length with a protective and insulative cover for carbon fiber strip 52, in the form of thermoplastic sleeve 53. In an embodiment, the heating element may be as shown and described in U.S. Pat. No. 7,247,822 that is incorporated herein by reference. Power for heating element 50 is provided via car power outlet adapter 54, connected to cord 56. Cord 56 is electrically connected to heating element 50 by connection 58, which is illustrated in detail in FIGS. 5-7.

In an embodiment of the invention, suitably mounted, preferably vertical/linear carrying handles 36 may be mounted to the wire rack to bear the forces of the contents and protrude through the outer shell layer of top 26. In an alternate embodiment, handles may be mounted to the outer shell with appropriate strain relief. Feet 38 (preferably rubber) may be provided in embodiments of the invention, to elevate food warmer 20 above any flat surfaces upon which food warmer 20 may be placed, to prevent marring thereof.

A metal rack 39, having a plurality of shelves 41, is provided. Preferably, rack 39 will be configured to support a substantial weight, e.g., on the order of 90 pounds.

Connection 58, which interconnects cord 56 to heating element 50, includes first connection element 60 and second connection element 62. First connection element 60 includes one or more locator pins 64 (four in the illustrated embodiment of FIG. 6), as well as an array of fixation elements 66 or energy directors. Second connection element 62 includes one or more locator apertures 68 corresponding to the one or more locator pins 64 of first connection element 62, as well as an array of fixation elements 70, which correspond to and align with fixation elements 66 of first connection element 62. Connection 50 is formed by placing an end of heating element 50, in which carbon fiber strip 52 is exposed, between first and second connection elements 62, 64, respectively. An end of cord 56, in which the insulation 72 has been removed to expose the conductor 74, is positioned adjacent the exposed portion of carbon fiber strip 52. Locator pin(s) 64 is/are aligned with locator aperture(s) 68, and first and second connection elements 62, 64 are pressed together, and exposed to sonic/ultrasonic waves of sufficient force, frequency and duration, to cause a number of fixation elements 66 and/or 70 to pass through carbon fiber strip 52, and abut and fuse to one another, effectively welding first and second connection elements 62, 64 together, and holding the exposed end of conductor 74 in tight electrical contact with the exposed portion of carbon fiber strip 52.

FIG. 9 is a schematic illustration of the electrical circuitry 90 for warmer 20. In an embodiment of the invention, Vᵢₙ=13.8_{VDC} (typical rated voltage for a motor vehicle interior power outlet), F1=10A (fuse typically located in a motor vehicle adapter 54) and R (representing a typical load for the heating element)=1.9 ohms. Thermostat 76 will be positioned in warmer 20 at a suitable location (which may be on the inner surface of innermost facing layer 42, or between insulation layer 48 and innermost facing layer 42), and operably inserted electrically between adapter 54 and heating element 50, so as to provide automatic control of the temperature within warmer 22, to maintain warmer temperature 22 within a desired, predetermined temperature range. The numerical values provided in FIG. 9 are provided merely by way of example, and the invention is not intended to be limited thereof.

The walls of box 22 may be fabricated using suitable known fabrication methods, in order to ensure that no heat leakage spots are created, especially along the edges and corners where two or three walls meet. Fabrication of warmer 20 may be accomplished by first forming the outer shell 40 of box 22. Heating element 50 is first attached to the insulation layer 48. Then innermost facing layer is applied over this assembly. Next, this assembly is formed and placed within the outer shell 40. Rack 39 (which in embodiments of the invention may be removable, e.g., for cleaning) will then be positioned in the inner cavity of box 22.

As an alternative to hinged front wall 24, a completely removable cover (not shown) may be provided, which can be inserted into (or placed over) front opening 23, to enable controlled access to the interior of box 22. Such a removable cover may still be fabricated in a manner similar to that of the rest of box 22, having an outer shell layer, an inner facing layer, and an insulation layer therebetween. In more complex embodiments of the invention, heating elements may be provided in either hinged front wall 24 or in a removable cover, though additional power transmission cords would be required to connect such heating elements to the electrical circuitry in the rest of box 22.

It is to be understood that the foregoing numerical values are provided simply by way of example, and that other embodiments of the invention may be provided with components having other numerical values, without departing from the scope of the invention.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Without intent to limit the scope of the disclosure, exemplary instruments, apparatus, methods and their related results according to the embodiments of the present disclosure are given below. Note that titles or subtitles may be used in the examples for convenience of a reader, which in no way should limit the scope of the invention. Moreover, certain theories may be proposed and disclosed herein; however, in no way, whether they are right or wrong, should they limit the scope of the disclosure so long as the disclosure is practiced according to the disclosure without regard for any particular theory or scheme of action

Unless otherwise defined, all technical and scientific terms used herein have the same meaning as commonly understood by one of ordinary skill in the art to which this disclosure pertains. In the case of conflict, the present document, including definitions will control.

The term “proximate” shall mean at or near the object being modified by the term “proximate”. Any numerical values provided herein are given by way of example and the scope of the claimed invention is not intended to be limited in any way thereby.

The foregoing description and drawings merely explain and illustrate the invention, and the invention is not limited thereto, except as those skilled in the art who have the present disclosure before them will be able to make modifications and variations therein without departing from the scope of the invention.

What is claimed is:

1. A food warmer, comprising:
a box, having an internal cavity, an opening defined in a face thereof, and a movable cover cooperating with the opening, to enable access to the internal cavity, the box further including
an outer shell;
an innermost facing layer;
an insulation layer disposed between at least portions of the outer shell and at least portions of the innermost facing layer;
a heating element disposed along inwardly facing-surfaces of at least portions of the insulation layer; and
a heating element comprises a carbon fiber filament, configured to radiate heat when an electric current is passed through it.

2. The food warmer of claim 1, wherein the box further comprises:
a power transmitting cord, connected at a first end thereof to a first end of the heating element, and passing through the outer shell; and
a contactor, attached to a second end of the power transmitting cord, and configured to be connected to an external power source.

3. The food warmer of claim 1, further comprising connection structure for maintaining the first end of the power transmitting cord in electrical contact with the first end of the heating element.

4. The food warmer of claim 3, wherein the connection structure comprises:
a first connection member, having at least one alignment member and at least one first fixation member, emanating from a first facing surface thereof;
a second connection member, having at least one alignment aperture, disposed therein for operable receipt of the at least one alignment member, for enabling alignment of the first and second connection members, when the first and second connection members are disposed in juxtaposed overlying relation to one another, the second connection member further having at least one second fixation member, emanating from a first facing surface thereof;
the first facing surface of the first connection member and the first facing surface of the second connection member being arranged to face toward one another, when the first and second connection members are disposed in juxtaposed overlying relation to one another,
the first end of the power transmission cord and the first end of the heating element being positioned between the first and second connection members, prior to the first and second connection members being disposed in juxtaposed overlying relation to one another,
at least one of the first and second fixation members being configured to pierce the first end of the heating element, and contact and fuse to the other of the first and second fixation members, upon application of pressure and vibration,
the first and second connection members, the first end of the power transmission cord and the first end of the heating element being subjected to pressure and vibrations, so as to cause the first and second fixation members to fuse together, to maintain the first and second connection members in their juxtaposed overlying relation to one another, to maintain the first end of the power transmission cord and the first end of the heating element in electrical contact with one another.

5. The food warmer of claim 1, wherein the outer shell is fabricated from corrugated polypropylene material.

6. The food warmer of claim 1, wherein the innermost facing layer is fabricated from a laminate of an inner layer of metal foil and an outer layer of plastic film.

7. The food warmer of claim 1, wherein the insulation layer is fabricated from one or more sheets of polystyrene foam material.

8. The food warmer of claim 1, wherein the contactor is operably configured to be attached to a power outlet of a motor vehicle.

9. The food warmer of claim 1, wherein the box further including a powered heating system further comprises a temperature control device configured for sensing temperature within the internal cavity of the box, and for regulating the transmission of power to the heating element, to maintain the internal cavity of the box within a desired predetermined temperature range, while the powered heating system is connected to a power source.

10. A method for fabricating a food warmer, comprising the steps of:
providing a box, having an internal cavity, an opening defined in a face thereof, and a movable cover cooperating with the opening, to enable access to the internal cavity, the step of providing a box further including the steps of
forming an outer shell;
placing an insulation layer within the outer shell;
disposing a heating element along inwardly facing-surfaces of at least portions of the insulation layer and the heating element comprises a carbon fiber filament, configured to radiate heat when an electric current is passed through it; and
placing an innermost facing layer within the outer shell, so that the insulation layer is disposed between at least portions of the outer shell and at least portions of the inner facing layer.

11. The method of claim 10, wherein the step of providing a box further comprises the step of:
providing a power transmitting cord, connected at a first end thereof to a first end of the heating element, and passing through the outer shell; and
providing a contactor, attached to a second end of the power transmitting cord, and configured to be connected to an external power source.

12. The method of claim 10, further comprising the step of forming a connection structure for maintaining the first end of the power transmitting cord in electrical contact with the first end of the heating element.

13. The method of claim 12, wherein the step of forming a connection structure further comprises the steps of:
providing a first connection member, having at least one alignment member and at least one first fixation member, emanating from a first facing surface thereof;
providing a second connection member, having at least one alignment aperture, disposed therein for operable receipt of the at least one alignment member, for enabling alignment of the first and second connection members, when the first and second connection members are disposed in juxtaposed overlying relation to one another, the second connection member further having at least one second fixation member, emanating from a first facing surface thereof;
arranging the first facing surface of the first connection member and the first facing surface of the second connection member to face toward one another, when the first and second connection members are disposed in juxtaposed overlying relation to one another,
positioning the first end of the power transmission cord and the first end of the heating element between the first and second connection members, prior to the first and second connection members being disposed in juxtaposed overlying relation to one another, wherein at least one of the first and second fixation members being configured to pierce the first end of the heating element, and contact and fuse to the other of the first and second fixation members, upon application of pressure and vibration,
subjecting the first and second connection members, the first end of the power transmission cord and the first end of the heating element being to pressure and vibrations, so as to cause the first and second fixation members to fuse together, to maintain the first and second connection members in their juxtaposed overlying relation to one another, to maintain the first end of the power transmission cord and the first end of the heating element in electrical contact with one another.

14. The method of claim 10, further comprising the step of fabricating the outer shell from corrugated polypropylene material.

15. The method of claim 10, further comprising the step of fabricating the innermost facing layer from a laminate of an inner layer of metal foil and an outer layer of plastic film.

16. The method of claim 10, further comprising the step of fabricating the insulation layer from one or more sheets of polystyrene foam material.

17. The method of claim 10, wherein the contactor is operably configured to be attached to a power outlet of a motor vehicle.

18. The method of claim 10, wherein the powered heating system further comprises a temperature control device configured for sensing temperature within the internal cavity of the box, and for regulating the transmission of power to the heating element, to maintain the internal cavity of the box within a desired predetermined temperature range, while the powered heating system is connected to a power source.
